(19) United States
(12) Patent Application Publication
(10) Pub. No.: US 2010/0235117 A1
(43) Pub. Date: Sep. 16, 2010

(54) Optical Gas Flow Meter

(75) Inventors: Ivan Melnyk, Coquitlam (CA); Yuriy Syvenkyy, Burnaby (CA)

Correspondence Address: Ivan Melnyk, 604 Cottonwood Ave, Coquitlam, BC, V3J 2S4, CA

(73) Assignee: Lauris Technologies Inc

(21) Appl. No.: 12/404,320

(22) Filed: Mar. 15, 2009

(51) Int. Cl. G01P 3/36; G06F 19/00

(52) U.S. Cl. 702/49; 356/28

(57) ABSTRACT

The invention provides an optical gas flow meter for measuring very low gas flow in a pipe. The meter comprises an optical system which transilluminates the pipe with plurality of parallel, collimated optical beams. The beams are deflected due to changes refractive index which is caused by a heater located in the pipe parallel to the beams. Deflected beams then pass through spatial filters and are detected by photodetectors. Stochastic signals from the photodetectors are further processed and gas velocity is calculated from cross-correlation function and known beam spacing. Multiple heaters allow the measurement of gas velocity at multiple points throughout the pipe.

### TECHNICAL FIELD

The present invention relates to measurement of flow of gases in pipes or flare stacks using optical means.

### BACKGROUND

Gas flow measurement is a challenging technical task because its motion is influenced by various physical parameters such as pressure, temperature, density, viscosity, pipe configuration, wall roughness, and obstacles located upstream and downstream from the measurement zone. In addition to that, gas cannot accumulate in a reservoir for verification purposes, this creates a problem for the calibration of gas flow metering means. Various gas flow metering techniques have been developed to overcome these challenges, and they are based on various fundamental principles such as mechanical, thermal, ultrasonic, and optical.

Optical gas flow meters can be utilized on laser Doppler velocimeters (LDV) which measures gas velocity based on the frequency shift caused by light scattering from moving media (gas). However, light scattering in clean gases is very weak and, because of that, LDVs require particle seeding which is not practical in most situations.

The laser-two-focus method (L2F) of gas flow measurement (see U.S. Pat. No. 7,265,832 “Optical flow meter for measuring gases and liquids in pipelines”) provides better sensitivity because laser beams are focused into two bright laser sheets and, therefore, very tiny particles can be detected. As a result, flow of many industrial gases, including natural gas in pipelines, can be measured. Focusing of laser light in the L2F gas flow meters, however, creates an inherent disadvantage for the L2F method, in that it allows for measurement of gas flow only in the limited volume. This type of flow measurement is called a single-point measurement and it requires special conditions such as an ideal flow conditioning to eliminate errors caused by uncertainty of the flow profile in the pipe. U.S. Pat. No. 6,275,284 “Pipeline Optical Flow Meter” describes a multi-point L2F flow meter in which each of three sensing points are created by a separate fiber optic system. This makes the design complex and fragile. Another disadvantage is that particles are not always present in processed gases (flares) and the number of effective particles decreases at low velocities due to particles dropping to the bottom of the pipe or sticking to the walls. This limits the practical application of the L2F flow meter since it has a minimum measurable velocity of not less than 0.1 ft/s. Environmental regulations require flare gases to be measured down to 0.1 ft/s or 0.03 m/s and this is unachievable using the L2F technique.

Optical flow meters based on a scintillation effect such as those described in U.S. Pat. No. 6,611,319 “Optical Flow Sensor Using a Fast Correlation Algorithm” can measure gas flow without the presence of particles in the gas. They operate by transilluminating the pipe with collimated light and measuring the cross-correlation of scintillating light on the opposite side of the pipe by using a set of two photodetectors. The photodetectors are spaced apart along the direction of the gas flow. Light scintillation occurs due to the local changes of the refractive index of the gas (similar to flickering of the horizon line on a sunny summer day or the flickering above a warm asphalt road after rain). Despite its ability to measure transparent gases and its capability of flow averaging along the pipe diameter, the proposed solution has a number of disadvantages. Gas moving in small pipes, under ambient temperature, possesses very minuscule changes in its refractive index. As such, its flow cannot be measured accurately by light scintillation. This effect is known in the steam industry where clean steam flow is visualized by adding visual flow indicators such as turbines, balls, etc., because flow of the transparent steam itself is not seen through the observing windows due to the lack of light scintillation. Optical scintillations are increased with optical path, for same gradient of the refractive index, with the longer optical path possessing stronger scintillations. Therefore, an optical scintillation meter can be applied to very large pipes or flare stacks only where tiny angular displacements of the optical beams turn into measurable fluctuations of the light intensity at the receive aperture. Flare gas stacks typically range from a few meters to tens of centimeters. This small size is not sufficient for the reliable operation of a cross pipe optical scintillation meter. Despite transilluminating the whole pipe, optical meters based on scintillation do not provide flow averaging along the pipe diameter due to the distribution of scintillation vortices throughout the pipe. Because of heat exchange, stronger fluctuations may occur closer to the pipe wall where velocity is low. Such fluctuations will contribute largely to a cross-correlation as opposed to weaker scintillations in the middle of the pipe where flow is faster. For this reason, scintillation flow meters can be used only for flow indication rather than for flow measurement and the name “flow sensor” instead of “flow meter” was properly used by the inventor.

An object of the present invention is to provide an improved optical gas flow meter which can operate in clean gases without particle seeding.

Another object of the invention is to provide an optical gas flow meter which can measure gas flow at multiple points across the pipe, thus making the gas flow meter less dependent on the flow profile.

Yet another object of the invention is to provide an optical gas flow meter which can measure very slow gas flow, in the order of one centimeter per second, to comply with recent environmental regulations.

### SUMMARY

According to the present invention, at least two narrow parallel beams of light are delivered through transparent windows in the pipe. The beams are spaced apart along the direction of the flow. A thin rod is placed along the light beams and the rod is placed in front of the beams so gas hits the rod before it reaches the light beams. A number of electrical heaters are located on the rod which can operate independently from each other. The location of the heaters is known, for example, they can be equidistantly located along the rod.

Each heater creates a local disturbance in the refractive index of the gas which is much stronger than the weak natural vortices found throughout the pipe. The heaters can be powered one by one in a consecutive fashion, with only one heater being on at any one given time. Using this approach, strong scintillations are created at each predetermined location and gas flow velocity can be measured at multiple points using cross-correlation techniques.

The signal-to-noise ratio is also improved by using spatial filtering. Spatial light filtering is the blocking of straight light being emitted from the light source while allowing only scattered and deflected light to be detected and processed.

### BRIEF DESCRIPTION OF DRAWINGS

FIG. 1 is a schematic representation of the optical flow sensor according to prior art at.

FIG. 2 is a schematic representation of the optical flow meter according to the first embodiment of the invention.

FIG. 3 is a schematic showing how the prism system increases the path length and results in the enhancement of scintillations

FIG. 4 is a schematic of the longitudinal arrangement of the scintillation flow meter.

FIG. 5 is an example of how the longitudinal arrangement shown in FIG. 4 can be used in a vertical section of the flare stack.

FIG. 6 is a schematic showing the means for generating the optical scintillations in the flare stack.

FIG. 7A shows an example of how the optical scintillations can be generated as shown in FIG. 6 in order to measure the flow profile.

FIG. 7B shows an example of the flow profile generated by a multi-point flow measurement as depicted in FIG. 7A.

FIG. 8A is a schematic representation of the scintillation generating means located on the wall inside in the pipe.

FIG. 8B is the same as FIG. 8A showing the external location of the scintillation generating means.

FIG. 9A describes the scintillation pattern observed at low gas velocity.

FIG. 9B describes the scintillation pattern observed at medium gas velocity when scintillation is generated by both mechanically and thermally induced turbulence.

FIG. 9C describes the scintillation pattern observed at high velocity when mechanically induced turbulence dominates over thermally induced turbulence.

FIG. 10 is a schematic of the signal processing means.

FIG. 11 is an example of cross-correlation functions calculated for three different gas velocities: 0.09, 0.28, and 1.71 m/s.

FIG. 12 is data from an air test on very low flow measurement using an experimental model of the optical gas flow meter compared to a reference ultrasonic flow meter.

### DESCRIPTION

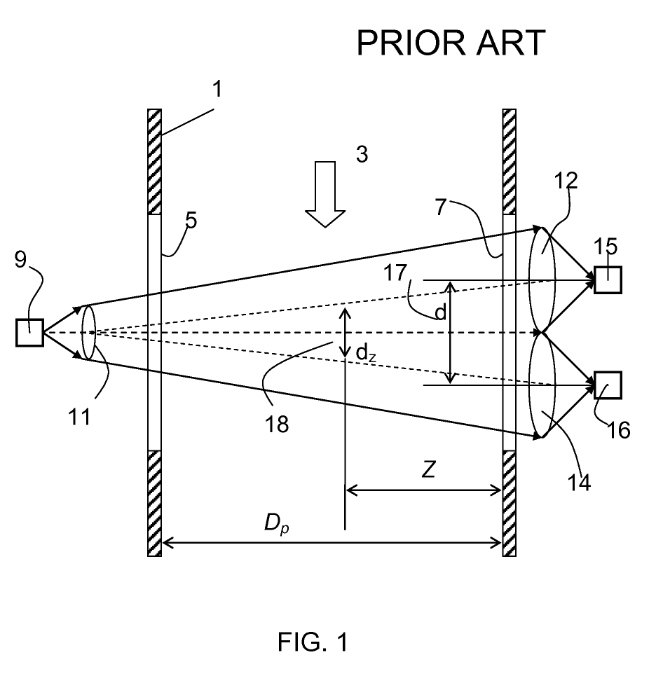

A schematic presentation of prior art described in U.S. Pat. No. 6,611,319 is provided in FIG. 1. A pipe 1 with gas stream 3 flowing in it has two optical windows 5 and 7 located across from each other on opposite sides of the pipe to transmit light from a light source 9. Light is transmitted by means of transmit optics 11 and it is collected by a pair of the receive optics 12 and 14 coupled to detectors 15 and 16, respectively. A spacing d (17) is set between the optical axis of the receiving lenses 12 and 14. The spacing is oriented along the gas flow and it defines the gas velocity either by detecting the position of the peak in cross-correlation function between two signals from photodetectors 15 and 16 or a slope of the cross-correlation function or by other algorithms which are described in details in Ting-I Wang, G. R. Ochs, and R. S. Lawrence: “Wind measurements by the temporal cross-correlation of the optical scintillations”, Applied Optics, v. 20, No 23, p. 4073-4081, 1981. Independent of the algorithm, the velocity detected by the scintillation flow sensor with two separated photodetectors is defined as

V=d/τ (1)

where τ is the lapse time between two stochastic electrical signals from photodetectors 15 and 16.

The schematic in FIG. 1 is shown to follow the preferred geometry described in U.S. Pat. No. 6,611,319, namely:

the light source 9 is a single laser diode or LED (light emitting diode);

the transmit optics 11 represents a collimating lens having a diameter of about one inch or Dₜ=25.4 mm;

the receive optics 12 and 14 represent receiving lenses of two inches in diameter each or Dᵣ₁=Dᵣ₂=50.8 mm.

It become apparent from FIG. 1 that such an arrangement makes the spacing d=50.8 mm (a minimum value if the receive lenses 12 and 14 are adjacent) meaningful only in proximity to the receive optics. Further from the pipe wall, the spacing d, (18) is linearly reduced with the distance Z and it becomes practically zero at the transmit window 5. As spacing d_{z} changes along the pipe diameter Dₚ, the velocity V can be defined from the equation (1) only in the area adjacent to the pipe wall, or at Z→0. The gas flow velocity is therefore undefined for the main portion of the pipe. The flow distribution along the cross section of the pipe is fairly complex and from an understanding of fluid dynamics it is known that: 1) gas velocity at the pipe wall approaches zero whether flow is laminar or turbulent, 2) it depends on boundary conditions, and 3) it is not representative of the total flow in general.

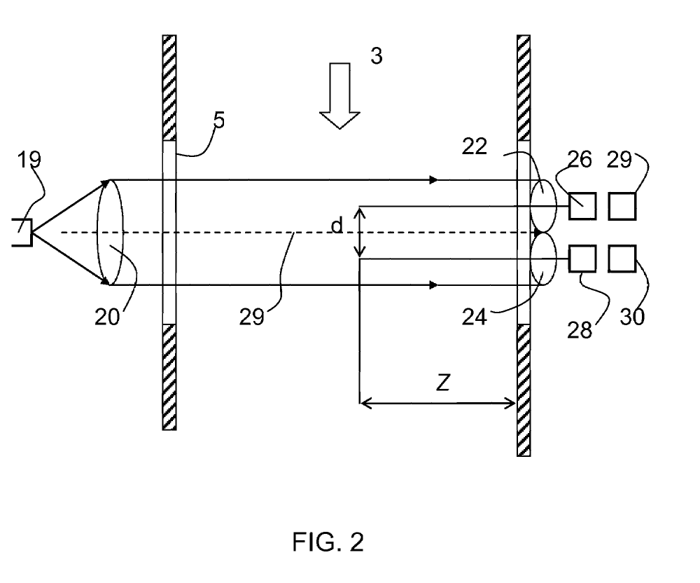

Improvements should therefore provide a constant spacing d_{z} along the pipe diameter as is shown in FIG. 2. Here a light source 19 illuminates the stream of gas 3 in the pipe through the optical window 5 using a transmit optics 20. The illumination can be accomplished by a number of means starting from a single collimating lens or including a plurality of light sources such as multiple LEDs or laser diodes located along the pipe, each coupled to collimating optics. Receive optics according to the first embodiment may include two receiving lenses 22 and 24 each space apart similarly to FIG. 1. A plurality of receiving lenses can be used, each coupled to a corresponded light source if more than one LEDs or laser diodes are used. It is important that the illumination be provided by collimated and not divergent beams so that the spacing d is constant along the pipe diameter 29 and the device not only indicates the presence of gas flow in the pipe but is able to provide a true measurement of the gas velocity.

According to second embodiment, the optical gas flow meter that takes into account the scintillation effect includes the spatial filtering means 26 and 28 which are preferably independent of each detection channel. The spatial filtering means improves the signal-to-noise ratio by reducing the amount of straight light. Only light scattered at local disturbances will reach the photodetecting means 29 and 30. Straight light from the light source is blocked by the spatial filtering means. Increasing the signal-to-noise ratio from the primary sensors allows improved accuracy of the whole device. The need for using spatial filtering is dictated by the short path length which is limited by the size of the flare stack. The intensity of the light fluctuations from a point light source collected at the receive optics is defined (see Equation (1) in U.S. Pat. No. 6,496,252) as:

$$σ = \text{?} , 5631 {( \frac{2 π}{λ} )}^{{}^{\text{?}} / 6} \int d {zC}_{n}^{2} ( z ) [ \text{?} {z ( 1 - \text{?} / L )}^{5 / 6} \text{?} \\ \text{?} \text{indicates text missing or illegible when filed} \qquad ( 2 )$$

where λ is the wavelength, L is the path length, Cₙ² is the refractive-index structure parameter. From equation (2), one can see that light oscillation is changed with the path length as L². The above mentioned paper by Ting-Wang et al. provides a similar formula for σ in which the oscillation intensity is proportional to L^{11/6}. Without giving too many theoretical details on which power in L is to be used, it becomes apparent that scintillations are rapidly reduced with shortening the path length. The path length L is equal to pipe diameter, Dₚ, in a round flare stack if light is delivered perpendicular to the flow direction.

Spatial filtering can be accomplished in a number of ways such as using schlieren techniques, for example. The advantage of detecting weak oscillations by using schlieren methods is described by T. I. Arsen'yan et al, “Application of schlieren methods in recording weak variations of the intensity of coherent optical radiation in the atmosphere”, Sov. J. Quant. Electron. v. 5, No. 6 p. 650-652. A practical application of the spatial filtering based on two gratings for measurement of crosswind is disclosed in U.S. Pat. No. 5,159,407 “Single-ended dual spatial filter detector for the passive measurement of winds and turbulence aloft”. Spatial filtering can be effectively applied for improving the performance of the optical gas flow meters in a passive way.

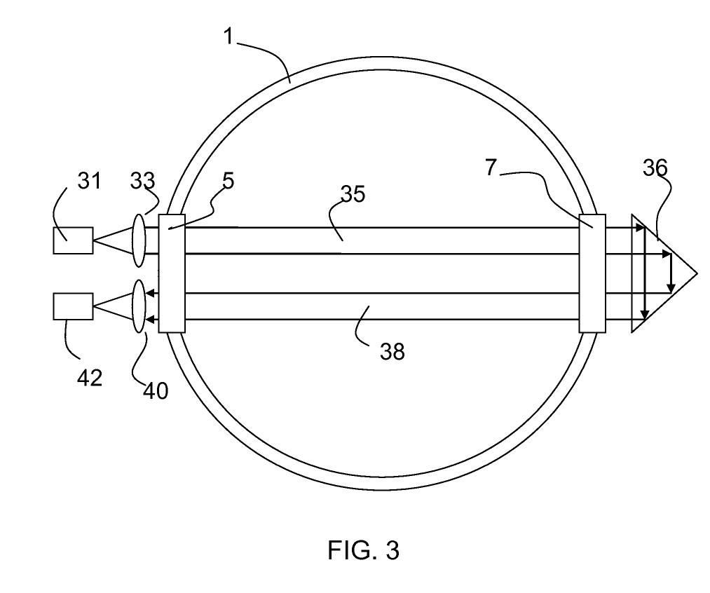

The path length, L, can be increased by applying various designs, a practical way is to use a prism system as shown in FIG. 3. A light source 31 illuminates the gas by transmit optics 33 producing a plurality of collimating light beams 35 (only one is shown in FIG. 3 because of the front view). The beams are reflected by a prism 36 and plurality of returning beams 38 cross the pipe in the opposite direction. They then pass another measuring zone where optical oscillations are independent from those caused by beams 35. The light is collected by a receive optics and spatial filtering 40, detected by photodetecting means 42 and processed further. This arrangement is different from the one described in U.S. Pat. No. 5,131,741 “Refractive velocimeter apparatus” where direct and reflected beams cross the same space. With this respect it is important also that prism 36 does not reflect the light like a retroreflector, otherwise scintillations will be heavily suppressed by the stabilizing effect of the retroreflector. The prism design doubles the path length thus making the optical scintillation meter suitable for smaller pipes. An additional advantage of the prism design is that it expands the measuring zone by providing measurement over a large cross section area of the pipe and, therefore, improves flow integration. This effect can be further enhanced by using multiple reflections from a number of reflectors and prisms located around the pipe.

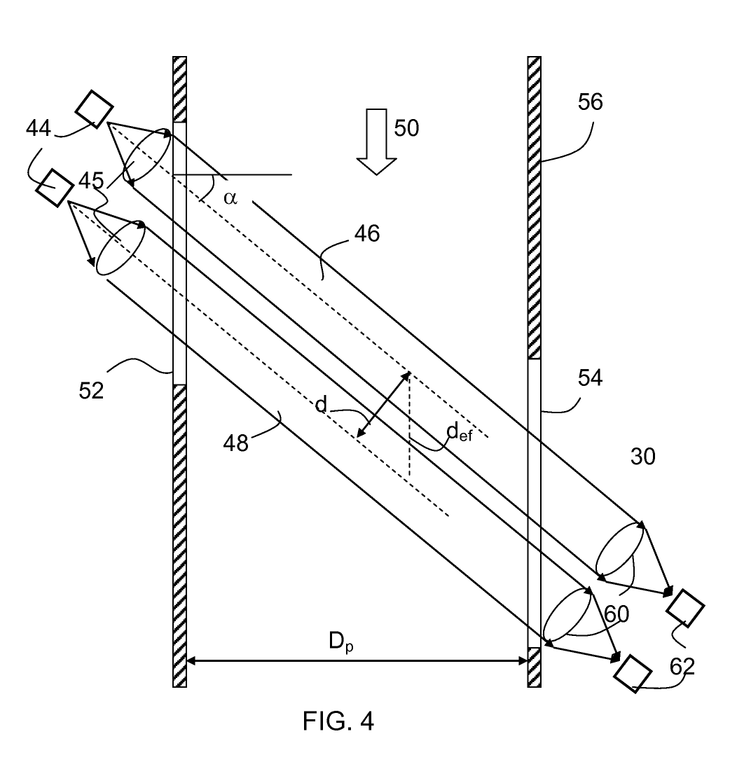

Unlike the L2F method, the optical scintillation method allows for a longitudinal optical path. An example of the schematic of the longitudinal arrangement is shown in FIG. 4. Light sources 44 and transmit optics 45 provide collimating light beams 46, 48 which illuminate the gas flow 50 through a transmit window 52 under an angle α. A receive window 54 is located on the opposite wall 56 of the pipe and transmits the light to a receive optics and spatial filtering 60, the scintillating light is detected by a photodetecting means 62. The longitudinal arrangement increases the path length to

$$L = \frac{{D}_{p}}{cos α}$$

The lapse time τ calculated from the cross-correlation function of the signals from photodetecting means 62 should account for the effective beam spacing to be used in equation (1):

$${d}_{ef} = \frac{d}{cos α}$$

where d is the geometrical spacing between the beams 46 and 48.

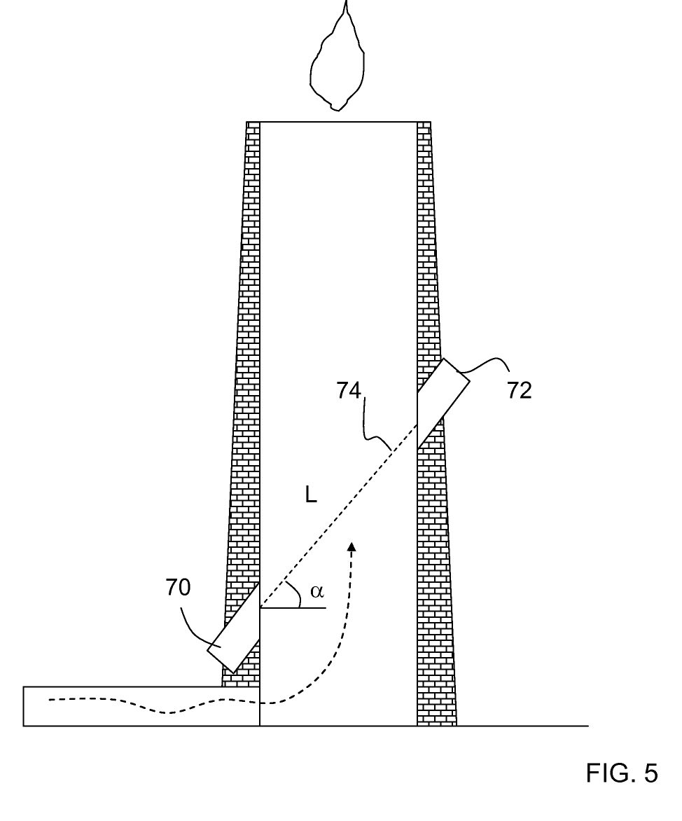

Since typical flare stacks are high, the vertical part of the flaring system can be effectively used for increasing the path length L as is shown in FIG. 5. First an optical head 70 is located on one side of the flare stack while another optical head 72 is mounted on the opposite side. One of the optical heads includes at least one light source and a transmit optics and another optical head has a receive optics and photodetecting means or a prism system as explained in FIG. 3. Optical heads analyze the optical scintillations along the line 74 which is under angle α to the cross-section of the flare stack. In addition to increasing sensitivity due to large L, the extended path length L provides the higher flow averaging by integrating the flow profile along the long distance. As opposed to ultrasound, light beams can be effectively collimated at long distances with minimum signal loss, the optical path length of tens of meters is easily achievable using the longitudinal design, therefore, even minuscule gas flow can be detected by this way.

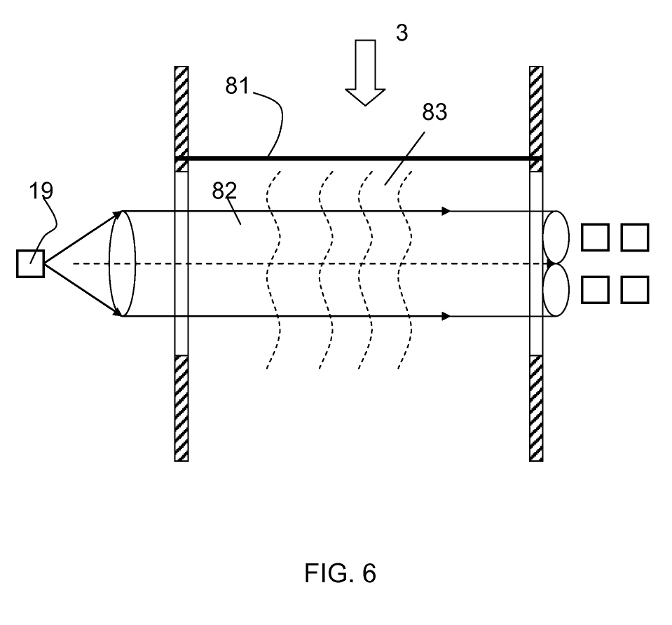

Yet another embodiment of the present invention includes an active means for improving the signal strength. Even in the largest flare stacks which have diameters of a few meters, scintillations are not noticeable, in particular, when flare gas flows under ambient temperature. Usually flaring occurs under minimum possible flows (a fraction of meters per second) in order to reduce gas waste. Environmental regulations in California required the measurement flow of flare gases down to 0.1 ft/s or 0.03 m/s. Measurement of such slow gas flows by optical means requires the generation of optical scintillations in the pipe. FIG. 6 shows an example of the means for generating the optical scintillations. A wire or a rod 81 is installed across the pipe parallel to the optical beams 82. The wire has a temperature only a few degrees higher from the ambient temperature. The temperature gradient generates strong scintillations 83 across the pipe which can then be detected and analyzed by the receiving optics, spatial filtering and photodetecting means.

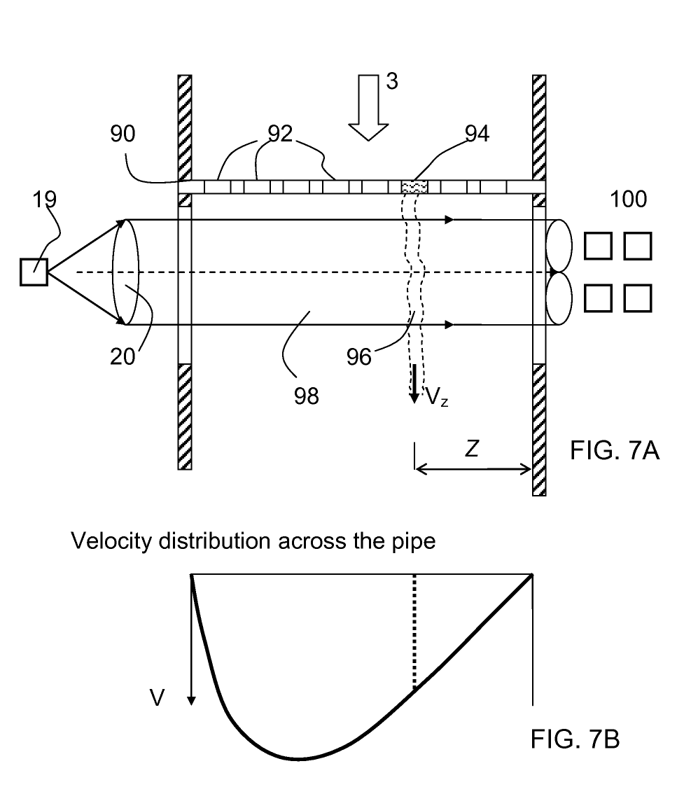

Means for generating optical scintillations allows for the measuring of gas flow at multiple points across the pipe. An example of multiple point measurement is shown in FIG. 7A. A thin rod 90 includes a plurality of local micro-heaters 92 which can operate independently from each other. Each micro-heater, such as micro-heater 94, for example, heats up the gas locally and creates local thermal turbulences 96 which are moved with the gas and create localized scintillations. Velocity of the local scintillations is detected by optical beams 98 in conjunction with a detecting optics 100. This velocity equals to the local gas flow velocity V_{z} at the distance Z from the pipe wall. The micro-heaters can be turned on in any order, they would preferably operate in a sequential mode, i.e. they are turn on and off one by one. After reading local velocities from all micro-heaters, the flow profile can be obtained as shown in FIG. 7B. The velocity distribution or flow profile also provides useful information about flow regime in the pipe in addition to total or bulk velocity V_{bulk} which is calculated by integrating the local velocities as:

$${V}_{bulk} = \frac{1}{{D}_{p}} {\int }_{0}^{{D}_{p}} {V}_{z} d z$$

This feature is not achievable by any other flow metering techniques including ultrasonic flow meters and multi-point Pitot tubes which all provide only integrated velocity. Another advantage of the distributed heating shown in FIG. 7A is that it reduces the total power consumption of the device.

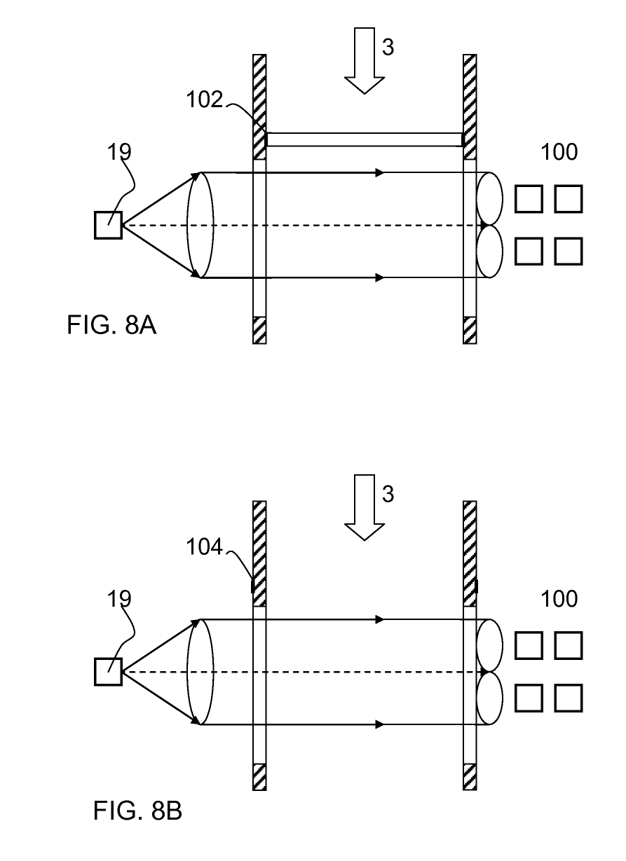

In smaller pipes where knowledge of flow profile is not as important as in the large flare stacks and average V_{bulk} is sufficient, the means for creating optical scintillations can be located circularly on the wall either inside (FIG. 8A) or outside (FIG. 8B) of the pipe. This solution is particularly beneficial for venting pipes which are typically from 1 to 3 inches in diameter. Flow rate of vent gases is extremely low and any pressure drop caused by the flow meter is undesirable.

Means for generating scintillations shown in FIG. 6, FIG. 7A and FIG. 7B are minimally intrusive. They cause negligible pressure drops in the large flare stacks because heated rods or wires can be quite thin. The aerodynamic drag force applied to the rod in the pipe is calculated by a generic equation:

$${F}_{d} = \frac{1}{2} ρ {V}^{2} A C$$

where ρ is the gas density; A is the reference area of the rod; C is the drag coefficient. Assuming that heater is ¼ inch or 6.35 mm in diameter, the stack has diameter Dₚ=1.0 m, and ρ=1 kg/m³ (this is close to density of the air at normal conditions), the maximum drag force during the blow-up event at Vₘₐₓ=100 m/s will be only F_{d}=20N. Regular stainless steel tubing with outer diameter of ¼ inch withstands this force.

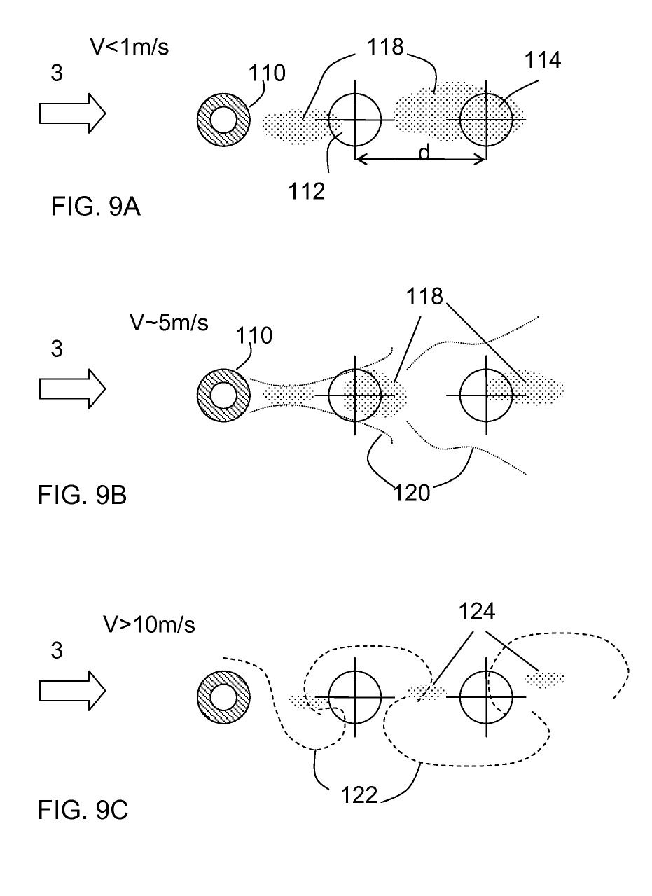

A wire or a rod inserted in the flare stack causes flow vortices which are in many cases sufficient for detecting optical scintillation without heating the insert. In this case, the inset is functioning as a regular bluff body. This fluid dynamic effect is particularly pronounced at velocities above 10 m/s where mechanically induced turbulence dominates over thermally induced turbulences. The latter is reduced because the inserts are cooled at high velocity similarly to cooling of the heated contacts in thermal mass flow meters. FIG. 9A describes the case with low gas flow, V<1 m/s. A heater 110, shown as a cross-section along the gas flow 3 and perpendicular to optical beams 112 and 114, creates thermally induced turbulences 118 which are relatively large and modulate optical beams with low frequencies. Mechanically induced vortices practically do not contribute to the light scintillation. As gas velocity increases, the size of thermally induced turbulences is reduced while contribution from vortices 120 increases (FIG. 9B). At gas velocity above 10 m/s, mechanically introduced vortices 122 dominate in light oscillations while thermally generated turbulence contributes to much weaker and high frequency oscillations (FIG. 9C)

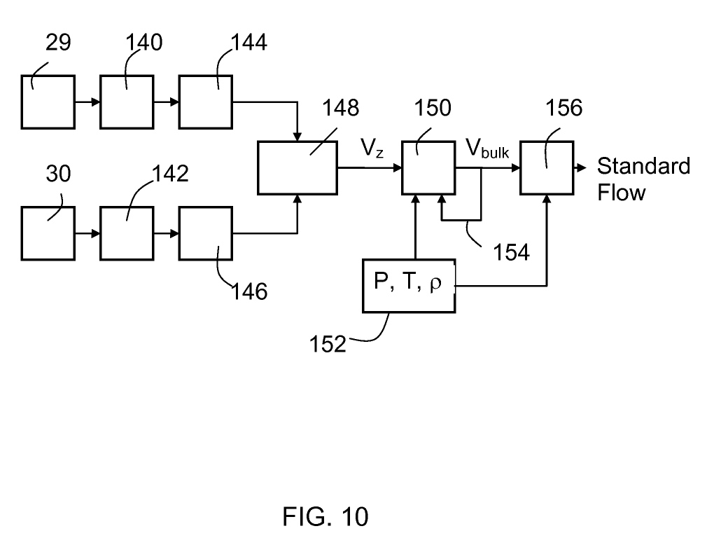

With reference to FIG. 10, signal processing means are further described. Photodetecting means 29 and 30 generate electrical signals which are proportional to intensities of optical scintillations σ² in each channel. Preferably photodetecting means are photodiodes such as PIN-photodiodes or avalanche photodiodes, however, photomultipliers (PMT) are preferable for achieving higher sensitivity of the device to very slow gas flow. Electrical signals are amplified by amplifiers 140, 142 and digitized by analog-to-digital converters 144, 146. Digital signals are processed in a signal processing unit 148 which calculates local velocity V_{z} based on cross-correlation techniques or other methods for processing stochastic signals. The signal processing unit is preferably a digital signal processor (DSP). The average or bulk velocity, V_{bulk}, is calculated as a next step 150 which may include calculation of Reynolds number, Re, and for which, therefore, external data 152 on pressure, temperature and density is provided. Reynolds number is frequently calculated based on current V_{bulk} value, therefore, a calculation loop 154 may be used until the final value of V_{bulk} is obtained. The external data 152 is used in a flow processor 156 which calculates the standard flow rate or mass flow rate based on approved algorithms and instructions. The flow processor may have a display for indicating the flow rate, a means for storing the data and sending the data further by communication wires or by wireless communication means.

Preferably the local velocity V_{z} is calculated based on lapse time r determined from the location of the peak of cross-correlation function K(τ) between signals U₁(t), and U₂(t) from photodetecting means 29 and 30:

$$K ( τ ) = \frac{1}{T} {\int }_{0}^{T} {U}_{1} ( t + τ ) {U}_{2} ( t ) d t$$

where T is the integration time. The exact algorithm can be performed digitally in a number of ways including those described in U.S. Pat. No. 6,611,319; this is not critical considering the modern capabilities of fast DSP.

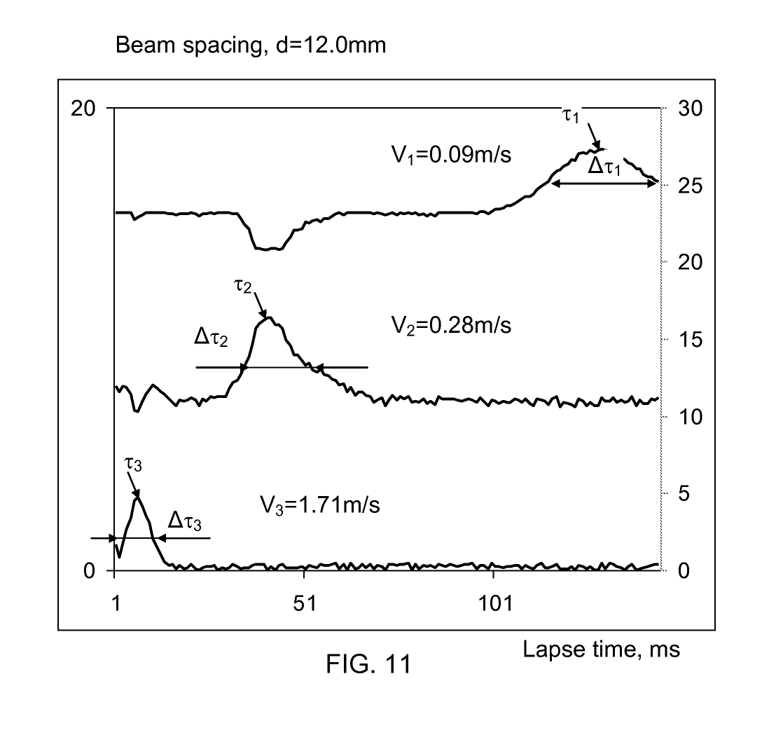

FIG. 11 shows an example of three cross-correlation functions recorded in a laboratory setup with 8 inch pipe and beam spacing d=12.0 mm. Peaks of K(τ) were found to be equal: τ₁=129.5; τ₂=42.3; and τ₃=7.0 ms which correspond to velocities V₁=0.09; V₂=0.28 and V₃=1.71 m/s, respectively. Change of the lapse time r with velocity V is associated with changes of the K(τ) width Δτ, the slower velocity, the wider cross-correlation function is. This is happening because frequencies of optical scintillations are changed with velocity, the higher velocity, the higher frequency of the scintillations, and consequently, frequency of signals from photodetecting means. The width Δτ can be calculated at a certain level of the K(τ) function (such as 50% or other) or by integrating the K(τ) value and dividing by its peak, etc. Usually width provides less sensitivity to velocity as compared to the peak location. Nevertheless, this method can be applied in combination with the lapse time measurement for the purpose of avoiding the ambiguity and improving the accuracy.

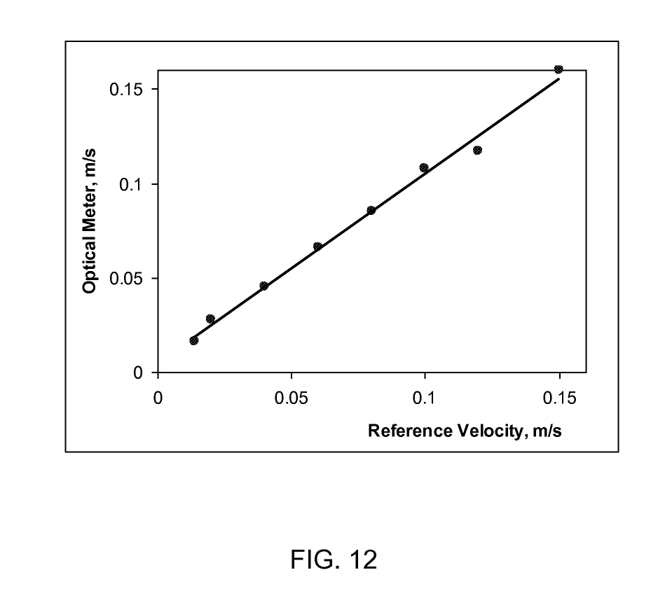

FIG. 12 shows the result of the air test performed in a 36-inch pipe with the experimental setup of the optical gas flow meter having the following parameters:

beam spacing d=18 mm;

receive and transmit optics Dᵣ=Dₜ=5 mm;

ambient air temperature Ta=20° C.;

heater temperature Th=35° C.;

heater diameter ⅛ inch or 3.1 mm;

reference flow meter, ultrasonic 4-path fiscal gas meter;

pipe reduction system from 36 inch to 4 inch coupling to ultrasonic meter.

The setup provided 9:1 pipe reduction which is equivalent to 81:1 velocity increase across the ultrasonic reference meter. The test data clearly indicates the capability of the proposed optical flow meter to measure ultra-low gas flow, down to centimeters per second range.

Optical scintillations increased with shorter wavelength according to equation (2). With this respect, blue and UV LED are particularly advantageous for use in the scintillation optical flow meters. Short wavelength LED with a center line at 405 nm and UV LED with maximum intensity at 375 nm are commonly available and they provide significant optical power. Such light sources are spectrally matched with the PMT which provides the best signal-to-noise ratio among all photodetectors.

Although the present invention has been described by way of examples thereof, it should be pointed out that any modifications to these examples, within the scope of the appended claims, are not deemed to change or alter the nature and scope of the present invention.

What is claimed is:

1. An optical device for sensing the velocity of gas flowing in the pipe, the device comprising:
means for creating optical scintillations in said gas by introducing fluctuations of the refractive index along the measuring zone and illumination of the measuring zone with a plurality of collimated and parallel optical beams;
means for detecting said optical scintillations by passing said collimated optical beams through a spatial filtering means and registering received light by photodetecting means;
signal processing means calculating gas velocity from said detected optical scintillations.

2. An optical device for sensing the velocity of gas according to claim 1, wherein said means for creating optical scintillations are bluff bodies positioned in the pipe parallel to said collimated optical beams.

3. An optical device for sensing the velocity of gas according to claim 2, wherein said bluff bodies have heating means for heating the bluff bodies above temperature of said flowing gas.

4. An optical device for sensing the velocity of gas according to claim 3, wherein said heating means provide heating to the bluff bodies at temperatures from 1 to 20 degree above temperature of said flowing gas.

5. An optical device for sensing the velocity of gas according to claim 4, wherein said heating means comprises a plurality of local heaters operated independently and creating local optical scintillation in said flowing gas.

6. An optical device for sensing the velocity of gas according to claim 5, wherein said local optical scintillations are used for measuring local velocities of said flowing gas in the pipe.

7. An optical device for sensing the velocity of gas according to claim 1, wherein said collimated optical beams are directed perpendicular to the gas flow.

8. An optical device for sensing the velocity of gas according to claim 1, wherein said collimated optical beams are directed under an angle to the gas flow for purpose of increasing the optical path length.

9. An optical device for sensing the velocity of gas according to claim 1, wherein said collimated beams are combined in at least one pair of beams; beams in each pair are spaced apart a defined distance along the gas flow.

10. An optical device for sensing the velocity of gas according to claim 1, wherein:
said collimated optical beams are produced by light sources and transmit optics located in a transmit optical head positioned outside of said pipe;
said optical scintillations are detected by a second optical head which includes receive optics, said spatial filtering means and said photodetecting means and which is located on the opposite side of the pipe to said transmit optical head.

11. An optical device for sensing the velocity of gas according to claim 1, wherein:
said collimated optical beams are produced by light sources and transmit optics located in a transmit optical head positioned outside of said pipe;
said collimated optical beams which pass the measuring zone are reflected by a prism system positioned on the opposite side of the pipe to a detecting optical head which includes receive optics, said spatial filtering means and said photodetecting means.

12. An optical device for sensing the velocity of gas according to claim 11, wherein:
said transmit optical head and said detecting optical head are positioned in one active optical head;
said prism system is positioned in a passive optical head.

13. An optical device for sensing the velocity of gas according to claim 1, wherein:
said signal processing means consists of analog-to-digital converters and a digital processing unit;
said digital processing unit calculates the cross-correlation functions between electrical signals corresponding to each pairs of said collimated optical beams.

14. An optical device for sensing the velocity of gas according to claim 13, wherein:
said digital processing unit measures lapse time from cross-correlation functions between electrical signals corresponding to each pairs of said collimated optical beams;
the flow velocity is determined by dividing the spacing between corresponding pairs of said collimated optical beams over said measured lapse time.

15. An optical device for sensing the velocity of gas according to claim 13, wherein:
said digital processing unit measures the width of said cross-correlation functions;
the flow velocity is determined from a calibration look-up table which includes data points on widths of cross-correlation functions and reference gas velocities.
